(19) United States
(12) Patent Application Publication
(10) Pub. No.: US 2005/0107742 A1
(43) Pub. Date: May 19, 2005

(54) Shatter-resistant microprobes

(75) Inventors: Maysam Ghovanloo, Raleigh, NC (US); Khalil Najafi, Ann Arbor, MI (US); Kensall D. Wise, Ann Arbor, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: The Regents of the University of Michigan

(21) Appl. No.: 10/941,554

(22) Filed: Sep. 15, 2004

Related U.S. Application Data
(60) Provisional application No. 60/503,034, filed on Sep. 15, 2003.

(51) Int. Cl. G01N 23/00

(52) U.S. Cl. 604/117

(57) ABSTRACT

In some embodiments, without limitation, the invention comprises a micromachined probe with one or more buried flow microchannels, where at least one of the microchannels is filled with an organic polymer. In some additional embodiments, the invention comprises a micromachined probe having at least a portion of one external surface coated with an organic polymer. The internally or externally applied organic polymer increases the buckling strength of the micromachined probe and decreases the risk of fracture of the probe, or movement or migration of broken fragments, during insertion, use, or removal from biological tissues.

### CROSS-REFERENCE TO RELATED APPLICATIONS

This application claims priority based on U.S. Provisional Patent Application No. 60/503,034, filed Sep. 15, 2003, which is hereby incorporated by reference in full.

### GOVERNMENT GRANTS

This invention was made with government support under Grant #NIH-NINDS-NO1-NS-9-2304 from the National Institutes of Health (NIH). The government may have certain rights in the invention.

### FIELD OF THE INVENTION

The present invention relates generally to the field of implantable penetrating microelectrodes.

### BACKGROUND

Microprobes are an essential tool in neuroscience. Over the past decades, physiologists and neuroscientists have used these devices in their various forms to study and understand biological tissues by monitoring their electrical activity through recording, influencing their operation by electrical stimulation, or injecting drugs without imposing significant damage, especially in the delicate central nervous system

In terms of performance, microprobes can be categorized into recording, stimulating, and chemical (usually drug) delivery. There are also microprobes that can do two or all of these tasks at the same time.

In terms of size, those probes with the smaller dimensions, in the range of tens of microns down to submicrons, that satisfy the minimum required physical properties such as mechanical strength, are often preferred because the goal is to record, stimulate, or deliver chemicals without damaging the natural histological structure of the living neural tissue.

In terms of building material, microprobes can be divided into 3 categories:
Glass micropipettes
Metal microelectrodes, and
Thin-film micromachined probes.

The glass micropipettes often consist of a thin glass tube that is partially melted and drawn to a fine submicron tip. To make an electrical contact with the tissue at the probe tip, the glass micropipette can be filled with low melting point metal or alloy such as indium or silver solder before being drawn, or with an electrolyte and a metal wire after being drawn. The latter method has the advantage of removing the metal electrode from direct contact with the tissue, which maintains the electrolyte composition constant and increases metal-electrolyte junction stability by decreasing the current density at the junction. However, this type of electrode is very fragile and the tip can clog up during insertion. In addition, the overall structure has a large size and can only be used for acute experiments. This type of microelectrode therefore is better suited for intracellular recording where very small current levels are present and minimal damage to the cell membrane is of significant importance.

Metal microelectrodes are made of sharpened insulated wires or microneedles. The wire is usually made of stainless steel, tungsten, or platinum, which is sharpened at the tip by grinding or electrochemical etching. The metal electrode is then coated by one of many possible insulators such as varnish, enamel, lacquer glass, Teflon, silicone, Epoxylite, or Parylene. To make an uninsulated sharp tip, the wire may also be cut at an angle to make a smooth, chisel shaped tip. Single-wire metal microelectrodes are inexpensive, relatively easy to make, and now commercially available from companies such as A-M Systems Inc. (Everett, Wash.), as one example only. However, these microelectrodes limit the recording or stimulation site to the tip of the probe, which is the only exposed area and its dimensions cannot be precisely controlled. Arrays of metal microelectrodes are difficult to make with a high level of consistency because the electrical characteristics of the individual metal microelectrodes vary widely due to variations in the exposed area. Furthermore, once the electrode is implanted, the relative position of the sites cannot be easily determined. These in turn limit the reproducibility of the physiologic experiments and affect the accuracy of the statistical results.

Thin-film micromachined probes are the most recent type of microelectrodes that are made possible by the advancements in photolithography and thin-film technologies. Silicon is the most widely used substrate for this type of microprobe because of its unique physical characteristics and widespread use in the microelectronic industry. These probes provide more control over the size and electrical properties of the recording and stimulating sites or drug delivery channels. Furthermore, their silicon substrate allows integration of active circuitry that improves the quality of recording and stimulation applications as well as sensors, actuators, and valves that are needed for accurate and selective drug delivery, on the probe body. The result of this integration is reducing the overall size of the implantable Microsystems significantly. These are some of the reasons behind the use of these microprobes in an increasing number of neurophysiological experiments, with rising interest in using them in neurosurgery and human implants [1].

Thin-film micromachined probes are not yet fully commercialized, and there is ongoing research for improving their characteristics for various specific applications. There are currently two major academic suppliers, one led by K. D. Wise at the University of Michigan (“UM-probes”) [2, 3] and the other one led by R. A. Normann at the University of Utah (“Utah-probes”) [4, 5]. Both types of probes are in use by numerous research groups who, along with their interest, have expressed concerns about the mechanical strength of silicon substrate and its suitability for chronic biological applications, for the reasons that bulk silicon substrate is a hard, fragile material and the probe width and thickness cannot be increased to more than a few tens of microns due to physical tissue damage.

Silicon micromachined probes should be able to withstand multiple insertions and removals. In this regard, buckling strength is an important mechanical characteristic of an object that shows its resistance to bending while being under stress. The building material Young's modulus, cross sectional area, aspect ratio, and surface deflection (curvature) are among the parameters that affect the buckling strength of an object, which is measured in force/stress [6].

FIG. 1(A) shows a UM-probe which is connected to a downward moving shaft, equipped with a strain gauge transducer that measures the applied force while the probe buckles against the hard surface and finally breaks. The resulting force vs. displacement curve in FIG. 1(B) shows that as soon as the probe tip hits the hard surface at d=0 mm, it starts buckling and the force increases with a sharp rising slope. However, at a certain point, which is called the buckling point, the slope decreases significantly but still goes up until the fracture point. The amount of force at the curve turning point is known as the probe buckling strength. The physical properties of a silicon microprobe designed for a specific application should be such that its buckling strength is significantly greater than the force needed to penetrate that specific tissue and overcome the friction applied to the moving probe shank during insertion and removal [7, 8].

K. Najafi and J. F. Hetke have experimentally determined the strength of thin silicon probes in neural tissues [8]. They have shown that silicon probes 15 μm thick×80 μm wide can penetrate guinea pig and rat pia arachnoid layers without buckling or breakage and those probes that are 30 μm thick×80 μm wide can penetrate guinea pig and rat dura matter repeatedly without fracture. A research group led by D. B. McCreery at the Huntington medical research institutes has been able to do 5 insertions and removals with a 3-dimensional UM-probe array, using a handheld high speed inserter tool, into the lower lumbar enlargement of the spinal cord of an anesthetized cat, without any failure [9]. This is a good model for the human brainstem because both tissues are covered with a thickened pial membrane, which is more difficult to penetrate than the brain or spinal cord tissue and tends to break the probes.

Because thin-film micromachined probes are becoming increasingly popular in neurosciences and their usage in human neural implants is under investigation, safety is of high importance. Even though 5 insertions and removals can be considered adequate for some applications, safety bears improvement for human implants, especially since probe fracture was reported in the 6th or subsequent insertions due to accumulated stress, fatigue, and microfractures from the prior insertions and removals. Furthermore, if the insertion does not take place at a properly high speed and at the correct angle, fracture might happen in the first trial. Therefore, a 100% fracture free insertion cannot be guaranteed in silicon microprobes. However, of even more importance for human applications is that if for any reason fracture occurs during surgery or afterwards (in an accident, for example), the broken probe might possibly damage the surrounding neural tissue or migrate into the brain or other parts of the body. Thus, there is a need to design human probes so that they can be easily removed during the initial implantation or subsequent surgeries without leaving any pieces behind.

Unfortunately the fragile nature of silicon, similar to glass, may cause a silicon probe to break into several large or small pieces at the point of fracture, as shown in FIG. 2. In case of a fracture, there is some risk that small pieces of silicon might remain in the neural tissue or might migrate down into the brain. Even if the surgeon removes the body of the microprobe, he/she might not see all small fragments or may cause significant damage to the surrounding tissue if he/she tries to pull them out, since they usually have several sharp edges.

Thus there is an unmet need for microprobes that are resistant to fracture and breakage into independent pieces upon insertion and usage in a mammal.

### SUMMARY

The invention meets this unmet need by comprising, in preferred embodiments, a micromachined probe which is coated or filled with organic polymers, such as silicone elastomers, such that the probe's mechanical strength and integrity are enhanced. In accordance with the invention, in some embodiments, without limitation, the invention comprises a micromachined multichannel probe with one or more buried flow microchannels. A polymer in its uncured liquid phase is injected into the silicon probe microchannels and fills them. Then the polymer is cured into an elastic rubber while making stable covalent bonds with the walls of the channel. This internal elastic core which is flexible, as opposed to the more fragile substrate, tethers the probe's shanks to the body of the probe and also serves as a flexible spinal column in the shank, keeping bits and pieces together, should any of the shanks happen to break. In some additional embodiments, the invention comprises a micromachined probe having at least a portion of one external surface coated with an organic polymer. The internally or externally applied polymer decreases or eliminates migration of the broken shanks and other smaller fragments into the brain and also allows the surgeon to remove them along with the probe body.

Other aspects of the invention will be apparent to those skilled in the art after reviewing the drawings and detailed description below.

### BRIEF DESCRIPTION OF THE DRAWINGS

The present invention will now be described, by way of example, with reference to the accompanying drawings, in which:

FIG. 1(A) is a representation of a UM silicon probe under a downward moving shaft to measure the buckling force. FIG. 1(B) is a graph of a force vs. displacement curve showing the probe buckling strength and fracture points.

FIG. 2 is a photograph of the shattering of a bare silicon probe into several small and large fragments at the fracture point.

FIGS. 3(A)-(B) are perspective views of a micromachined drug delivery probe having three delivery channels along with recording and stimulating electrodes.

FIG. 4 is a schematic of one method used to fill a multichannel probe with uncured silicone elastomer.

FIG. 5 depicts the back portion of a single channel probe mounted on the PCB with one flow channel and five electrical connections.

FIGS. 6(A)-(B) are photographs showing top (FIG. 6(A)) and side (FIG. 6(B)) views of a fractured silicon drug delivery probe with silicone elastomer filling inside its channel.

FIG. 7 shows the cross section of a shatter-resistant microprobe made of a silicon drug delivery probe with a wide flow channel filled with silicone elastomer to form high tensile strength silicone hinges at any fracture point.

FIGS. 8(A)-(B) show a fractured silicon drug delivery probe with a layer of silicone elastomer on its top surface.

FIG. 9 is a representation of a fracture hinge comparing when the shanks are fractured toward the silicone layer (FIG. 9 (A)) and in the opposite direction (FIG. 9(B)).

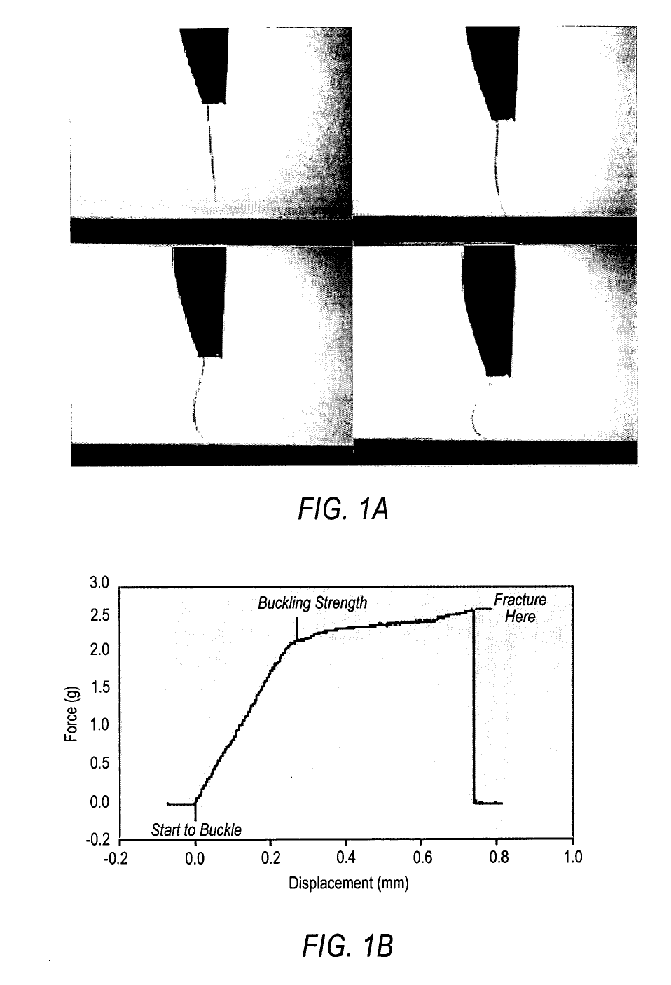

### DETAILED DESCRIPTION

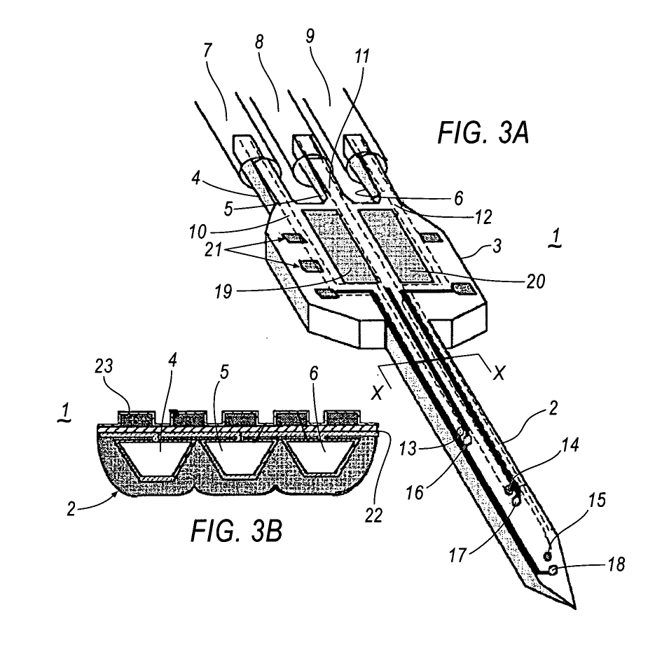

In some preferred embodiments, without limitation, the present invention comprises a micromachined multichannel fluid delivery probe with one or more buried flow channels in the probe substrate, resulting in a hollow-core device (FIG. 3). Other embodiments comprise other types of micromachined probes. The structure and fabrication process of fluid delivery probes is reported in detail in Reference 10 and in K. D. Wise, et al., U.S. Pat. No. 5,992,769 which discloses the structure and fabrication process of a silicon multichannel chemical delivery probe comprising, without limitation, certain embodiments of the present invention; Lin, et al., U.S. Pat. No. 5,855,801, disclosing a method for fabricating planar silicon microprobes usable for a 3-D microassembly of certain embodiments of the present invention; Normann, et al., U.S. Pat. No. 5,215,088, disclosing the structure and fabrication process of the Utah silicon 3D microelectrodes; and GartStein, et al., U.S. Pat. No. 6,379,324, disclosing an application for a chemical delivery probe. Each of the references and patents identified herein are incorporated fully by reference as though fully set forth herein.

By way of example only, without limitation, as disclosed in U.S. Patent No. 5,992,769, in some embodiments, the invention comprises a micromachined multichannel probe formed of a silicon substrate having a top surface with a longitudinal channel formed therein. A channel seal is arranged to seal the top surface of the silicon substrate and to overlie the longitudinal channel. Thus, the longitudinal channel is embedded in the silicon substrate.

In one embodiment, the channel seal is formed of a plurality of cross structures that are formed integrally with the silicon substrate. Each such cross structure is arranged to overlie the longitudinal channel, the cross structures being arranged sequentially thereover. In a preferred embodiment, each of the cross structures has a substantially chevron shape. In other embodiments, without limitation, series of holes or diagonal slots are suitable.

A first seal over the longitudinal channel is achieved by oxidizing at least partially the cross structures, whereby the spaces between them are filled. In a further embodiment, a dielectric seal is arranged to overlie the thermally oxidized cross structures, thereby forming a more complete seal and a substantially planar top surface to the silicon substrate. In one practical embodiment of the invention, the dielectric seal is formed of a low pressure chemical vapor deposition (LPCVD) dielectric layer.

In some embodiments of the invention, without limitation, control or other circuitry can be formed integrally on the silicon substrate. Such control circuitry may include other circuit structures, such as bonding pads and sensors. In embodiments of the invention where highly precise drug or chemical delivery is desired to be achieved, sensors and/or stimulation circuitry for sensing or inducing neural and other cellular responses can be formed in the silicon substrate. Such proximity of the sensor circuitry to the drug distribution nozzle facilitates placement of the sensor in close proximity to the chemical distribution nozzle, thereby solving a significant problem with prior art systems. Receiving, recording, and/or stimulating sites or circuitry may also be included in embodiments whose principal purpose is not drug or chemical delivery.

In some embodiments of the invention, microvalve arrangements can be formed in connection with the microchannel and under the control of the on-chip circuitry.

The silicon substrate may be formed, at least partially, of boron-doped silicon. Preferably the boron-doped silicon is configured as a boron-doped silicon layer that is formed by boron diffusion. An initial diffusion can be rather shallow, illustratively on the order of 3 μm and such a boron-doped layer will resist etching as the channel is formed. In other embodiments, without limitation, other structures and methods, such as a flow channel formed in silicon-on-insulator material, are suitable as well. [13]

In accordance with some embodiments of the invention, without limitation, a multichannel probe is formed of a silicon substrate having a top surface having a plurality of channels formed therein. Each such channel has a plurality of cross structures integrally formed therewith and arranged to overlie each of the longitudinal channels. The cross structures are arranged sequentially over the longitudinal channel. A channel seal is arranged to seal the top surface of the silicon substrate and to overlie the plurality of longitudinal channels.

In some embodiments, the silicon substrate is provided with a boron-doped portion in the vicinity of the longitudinal channels. The longitudinal channels are formed by a silicon etching process which is resisted by boron-doped cross structures. Thus, the etching process proceeds beneath the cross structures. Thus, as previously described, when the cross structures are subjected to thermal oxidation, the spaces therebetween are filled in. Also, a dielectric layer is applied thereover, further ensuring that a seal is achieved.

It is a significant aspect of the present invention that a boron diffusion be performable through the grating, in order that subsequent etching be permitted from the back of the wafer. Such etching from the back of the wafer is necessary to form a free-standing device. In other embodiments, without limitation, an SOI wafer may be suitable as well, since the buried oxide layer would stop the etch from the back.

After the microchannels are sealed, the upper surface of the dielectrics over the channels can be highly planar, and therefore, leads for recording and stimulating sites can be formed using conventional techniques.

FIG. 3(A) is a schematic representation of a three-channel drug-delivery probe 1 constructed in accordance with one embodiment of the invention, without limitation. As shown, drug-delivery probe 1 has a probe or shank portion 2 and a body portion 3 that are integrally formed with one another. Body portion 3 additionally has formed therewith, in this embodiment, three inlets, 4, 5, and 6. In certain uses, the inlets are coupled to respective supply tubes, that are shown as polyimide pipettes 7, 8, and 9. In certain embodiments of the invention, the rate of fluid flow through the polyimide pipettes can be monitored with the use of respective flow sensors (not shown).

In this embodiment, three microchannels 10, 11, and 12 are coupled respectively to inlets 4, 5, and 6. The microchannels continue from body portion 3 and extend along probe portion 2 where they are provided with respective outlet orifices 13, 14, and 15. Each such outlet orifice has arranged, in the vicinity thereof, a respective one of electrodes 16, 17, and 18. These electrodes are coupled to integrated circuitry shown schematically as integrated CMOS circuits 19 and 20 which are coupled to bonding pads 21.

FIG. 3(B) is a cross-sectional representation of drug-delivery probe 1 taken along line X-X of FIG. 3(A). The elements of structure are correspondingly designated. As shown in FIG. 3(B), drug-delivery probe 1, in its probe portion 2, has microchannels 4, 5, and 6 embedded therein, and has a LPCVD/thermal oxide layer 22 arranged thereover. A plurality of electrode conductors 23 are arranged over the LPCVD/thermal oxide layer.

In accordance with the present invention, in some embodiments, without limitation, at least one of the the hollow microfluidic channels of a fluid delivery probe is filled with an organic polymer. The organic polymer may be capable of making covalent bonds with the rigid silicon substrate walls inside the channel. The polymer in its uncured liquid phase is injected into the microchannel. The polymer is cured (e.g., polymerized), turning into an elastic rubber while sticking to the silicon walls of the channel by making stable covalent bonds. The resulting internal elastic core, which is flexible as opposed to the fragile bulk silicon substrate, tethers the shanks to the body of the probe and also serves as a flexible spinal column in each shank, keeping all the bits and pieces together as a glue if any of the shanks happen to break.

Suitable liquid-type low viscosity polymers are known to those of ordinary skill in the art. As one example only, without limitation, silicones have shown suitability for both wires and silicon surfaces of the microelectrode arrays because of forming stable covalent bonds. For example, Nusil Technology (Carpinteria, California) MED-6015 silicone elastomer is a two-part, optically clear, solvent free, low viscosity silicone that can be cured at room or higher temperatures [12]. MED-6015 offers good physical and electrical stability at temperatures ranging from −65° C. to 240° C. and its primary applications are potting and encapsulation. Nusil Technology also offers the medical grade version of this silicon elastomer under the name MED-6215. Table 1 summarizes some of the typical properties of MED-6015.

TABLE I
MED-6015 SILICONE ELASTOMER TYPICAL
PROPERTIES [121

| Parameter | Value |
|---|---|
| Viscosity, Part A | 6000 cps |
| Viscosity, Part B | 100 cps |
| Mixing Ratio | 10:1 |
| Specific Gravity | 1.02 |
| Tensile Strength | 1100 psi |
| Elongation | 120% |
| Volume Resistivity | 10¹⁵ Ω/cm |
| Cure Time @ 25° C. | 7 days |
| Cure Time @ 100° C. | 1 hour |
| Cure Time @ 150° C. | 10 min |

Other suitable polymers known to those of ordinary skill, other than silicone elastomers, may comprise other embodiments of the invention.

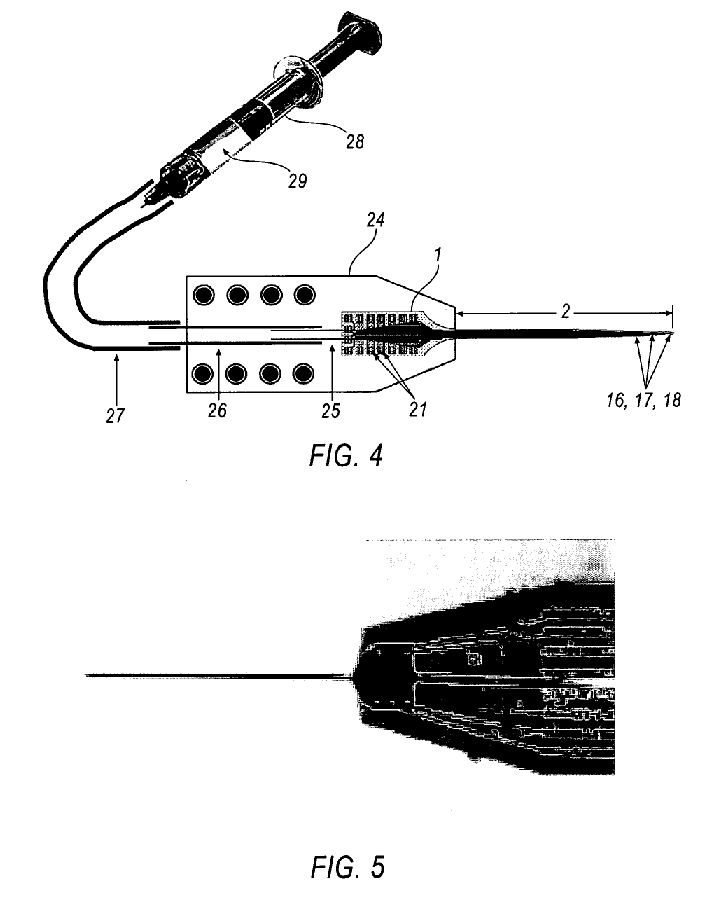

FIG. 4 shows a method used to fill probes with uncured silicone elastomer. The back-end of a drug delivery probe 1, which may also have one ore more sites and electrical connections to the sites along its shanks for recording and/or stimulation, was mounted on a custom-designed printed circuit board (PCB) 24, called a “stalk”, which is often used in acute experiments. Electrical connections are provided through ultrasonically bonded aluminum wires between the probe bonding pads and the PCB. Polyamide tubing 25 has been attached and sealed around the fluid ports at the rear of the probe. A conventional glass micropipette 26 is inserted on the other side of this tubing and sealed. FIG. 5 shows the back portion of a single channel probe mounted on the stalk PCB with one flow channel and five electrical connections [10]. The other end of the glass micropipette was inserted and sealed in a flexible PVC tube 27. A syringe 28 plastic tip was inserted into the other end of the PVC tube and sealed after its needle was removed.

A 2 cc syringe 28 with a 10:1 mixture of MED-6015 part A and part B compartments was filled and fixed it into its plastic tip. The uncured low viscosity silicone 29 was then injected into the probe through PVC, glass, and polyamide tubes. The fluid outlet orifice on the probe tip was observed under a microscope during the silicone injection to stop it as soon as a small silicon droplet was seen at the orifice. The probe was then detached from the PVC tubing at the glass micropipette junction and placed inside an oven for 1 hour at 100° C. for the silicone to be cured and turn into silicone rubber.

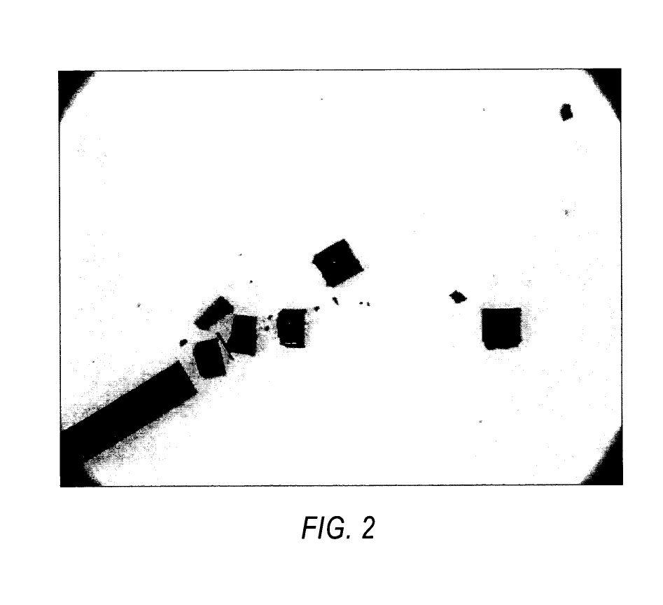

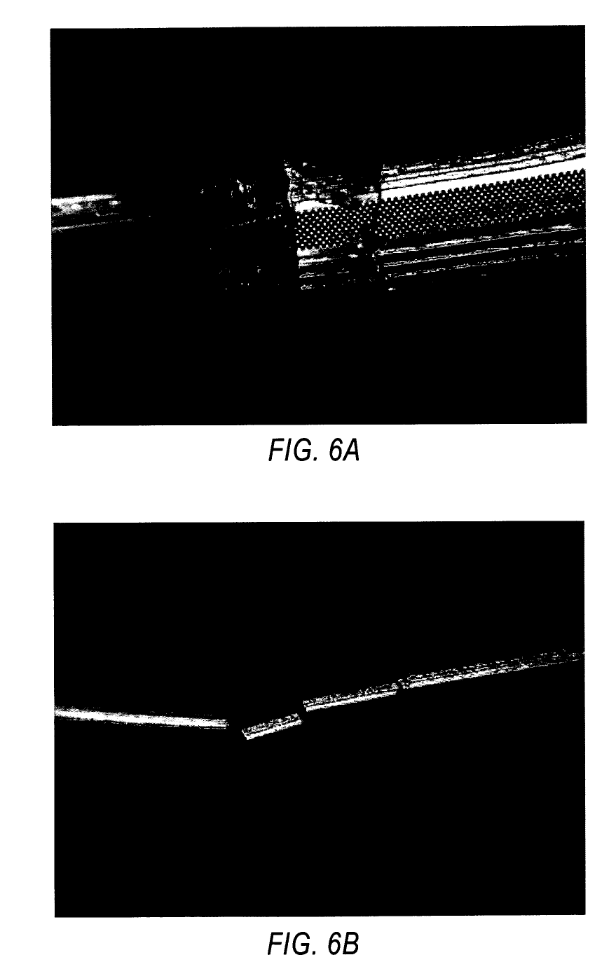

Several silicone filled probes were intentionally broken to see the tethering effect of the flexible silicone glue. FIG. 6 shows some of the results which strongly support the initial idea. As can be seen, several large and small fragments are held together by silicone at the fracture point and the entire probe is in one piece, in contrast to the shattered probe shown in FIG. 2.

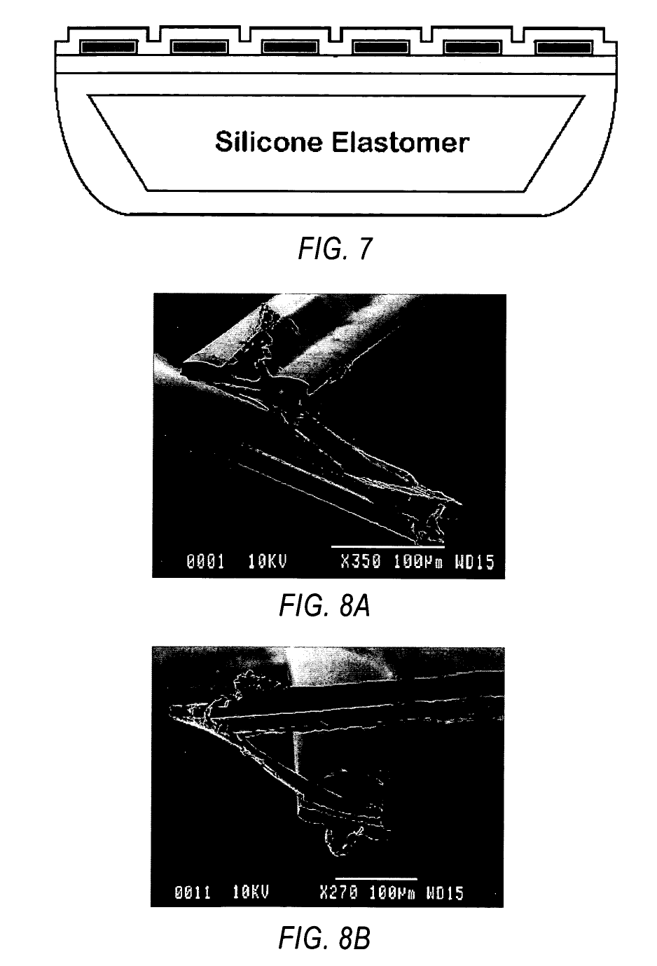

The tensile strength of the cured silicone rubber hinge at the fracture points depends on the size and cross sectional area of the trapezoidal flow channel(s). The probes used in this example were designed for delivery of chemicals at small rates, and each had a single 15 μm-wide flow channel. Yet the tensile strength of the silicone hinge is enough to anchor a fractured probe in place and do not let its fragments to migrate into the brain. However, in order to make the silicon rubber cord strong enough to pull the fractured shanks out of the neural tissue along with the body of the probe, specifically designed, wide flow channel probes such as the one shown in FIG. 7 are preferred.

Pulling the fractured shanks and fragments of a broken probe out of the neural tissue along with the body of the probe was demonstrated in cases where the excessive uncured injected silicone that was flowed out of the fluid outlet orifice at the tip of the probe had wetted the probe upper surface. This was similar to an additional wide channel on top of the probe with only one side of it bonded to the silicon substrate. A stronger tethering effect from the upper silicone layer was observed compared to the small buried channel silicone, which could still keep the pieces that had turned more than 180° together, as shown in FIG. 8. The tensile strength of the upper wide silicone layer was sufficient to pull the broken probe shanks out of agar gelatin, derived from Gracilaria, a bright red sea vegetable, which is known to have physical properties similar to the human brain neural tissue. Therefore, a wide flow channel filled with silicone elastomer that is stuck to all the surrounding silicon walls should be able to eliminate migration of the broken pieces away from the superstructure, as well as also pull all the broken shanks out of the neural tissue along with the body of the probe.

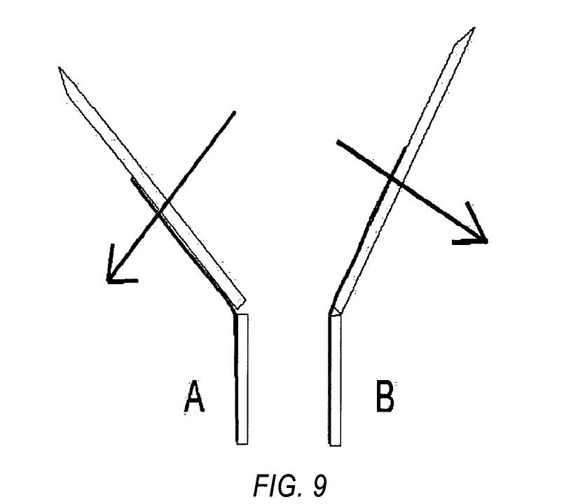

In some embodiments, without limitation, the invention comprises a micromachined probe having at least a portion of one external surface coated with an organic polymer. FIG. 8(A)-(B) shows a silicon drug delivery probe with a layer of silicone elastomer on its top surface. The tensile strength of the silicone at the hinge is high enough to keep the broken shank with the back-end even though it has turned more than 180°. FIG. 9 shows the disadvantage of a silicone layer on the back side of the probe is that the tensile strength of the hinge is large enough when the shanks are fractured toward the silicone layer (FIG. 9(A)) but not if the fracture is in the opposite direction (FIG. 9(B)).

Coating portions of the upper surface of a probe with silicone has a possible disadvantage of blocking the electrical connection between the probe sites and the tissue. Since silicone is optically clear, it cannot be removed from top of the sites with laser ablation. Therefore, it is preferable in some embodiments to have wide buried flow channels inside the shanks unless the probe is meant only for chemical delivery, in which case the entire probe except for the fluid outlet orifices can be encapsulated in silicone. In other embodiments, only the back-side of the silicon probes is coated, for example, for recording and stimulation probes that do not have any flow channels. In this embodiment, the tensile strength of the hinge would be large enough when the shanks are fractured toward the silicone layer (FIG. 9A) but not if the fracture is in the opposite direction (FIG. 9B) [9].

Other embodiments may comprise, without limitation, a micromachined probe with at least one microchannel filled with a metal, or with any other material which can be applied in liquid form which will cure or solidify to supply strength to the structure and enhance the ability to withstand fracture of the outer shell. In some embodiments, without limitation, the inner bore of the channel may be non-uniform in diameter or texture to enhance the anchoring or attachments of fill material.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

### REFERENCES

[1] J. F. Hetke and D. J. Anderson, “Silicon microelectrodes for extracellular recording,” in Handbook of Neuroprosthetic Methods, W. E. Finn and P. G. LoPresti editors, CRC Press, Boca Raton, Fla., 2002.
(2] K. Najafi, K. D. Wise, and T. Mochizuki, “A high yield IC-compatible multichannel recording array,” IEEE Transactions on Electron Devices, pp. 1206-1211, July 1985.
[3] A. C. Hoogerwerf and K. D. Wise, “A three-dimensional microelectrode array for chronic neural recording,” IEEE Trans. Biomed. Eng., vol. 41, no. 12, pp. 1136-1146, December 1994.
[4] R. A. Normann, P. K. Campbell, and W. P. Li, “Silicon based microstructures for intracortical electrical stimulation,” in Proc. of IEEE Eng. Med. Biol. Soc., vol. 10, pp. 714-715, 1988.
[5] P. K. Campbell, K. E. Jones, R. J. Huber, K. W. Horch, and R. A. Normann, “A silicon-based, three-dimensional neural interface: Manufacturing process for an intracortical electrode array,” IEEE Trans. Bionied. Eng., vol. 38, no. 8, pp. 758-767, August 1991.
[6] S. H. Candal, C. D. Norman, and T. J. Lardner, “An introduction to the mechanics of solids,” Chapter 9, Prentice Hall, Englewood Cliffs, N.J., 1992.
[7] T. Moon, M. Ghovanloo, and D. R. Kipke, “Buckling strength of coated and uncoated silicon microelectrodes,” to be presented at the IEEE 25^{th} EMBS Conference, Cancun-Mexico, September 2003.
[8] K. Najafi and J. F. Hetke, “Strength characterization of silicon microprobes in neurophysiological tissues,” IEEE Trans. Biomed. Eng., vol. 37, no. 5, pp. 474-481, May 1990.
[9] D. B. McCreery, W. F. Agnew, L. A. Bullara, and A. S. Lossinsky, “A cochlear nucleus auditory prosthesis based on microstimulation,” Quarterly Progress Reports, NIH-NINDS contract No. NO1-DC-1-2105.
[10] J. Chen, K.D. Wise, J.F. Hetke, and S. Bladsoe, “A multichannel neural probe for selective chemical delivery at cellular level,” IEEE Trans. Biomed. Eng., vol. 44, no, 8, pp. 760-769, August 1997,
[11] D. Edell et al., “Insulating Biomaterials,” Quarterly Progress Reports, NIH-NINDS contract No. N01-NS-9-2323.
[12] Nusil Technology, “MED-6015 Optically clear potting and encapsulation silicone elastomer,” Product Profile, Available:

http:www.nusil.com/healthcare/restricted/lowC_elastomers/, cited in July 2003.
[13] K. C. Cheung, K. Djupsund, Y. Dan, and L. P. Lee, “Implantable Multichannel Electrode Array Based on SOI Technology,” IEEE J. Microelectromech. Systems, 12, pp. 179-184, April 2003.

1. A microchannel probe device comprising:
a silicon substrate having a top surface with one or more longitudinal channels formed in said top surface; and
a channel seal arranged to seal the top surface of the silicon substrate and to overlie said one or more longitudinal channels,
wherein at least one longitudinal channel is filled with an organic polymer.

2. The microchannel probe device of claim 1, wherein the organic polymer comprises a silicone elastomer.

3. The microchannel probe device of claim 2, wherein the silicone elastomer is curable.

4. A microchannel probe device comprising:
a silicon substrate having a top surface with one or more longitudinal channels formed in said top surface; and
a channel seal arranged to seal the top surface of the silicon substrate and to overlie said one or more longitudinal channels,
wherein at least one longitudinal channel is filled with a metal.

5. A microchannel probe device comprising:
a silicon substrate having a top surface with one or more longitudinal channels formed in said top surface; and
a channel seal arranged to seal the top surface of the silicon substrate and to overlie said one or more longitudinal channels,
wherein at least one longitudinal channel is filled with a liquid material which becomes a solid material after deposition in the channel.

6. A microchannel probe device comprising:
a silicon substrate having a top surface with one or more longitudinal channels formed in said top surface; and
a channel seal arranged to seal the top surface of the silicon substrate and to overlie said one or more longitudinal channels,
wherein at least a portion of the top surface of the substrate is coated with a curable organic polymer.

7. The microchannel probe device of claim 4, wherein the organic polymer comprises a silicone elastomer.
